(19) United States
(12) Patent Application Publication
(10) Pub. No.: US 2023/0391952 A1
(43) Pub. Date: Dec. 7, 2023

(54) Process For Preparing Polyether Alcohols Having A Low Metal Ion Content

(71) Applicant: Clariant International Ltd., Multenz (CH)

(72) Inventors: Markus LAUBER, Langen (DE); Reinhard VYBIRAL, Burgkirchen (DE); Stefan BRAND, Hirschberg-Leutershausen (DE); Olaf WACHSEN, Garching (DE); Elias KLEMM, Stuttgart (DE); Thomas LANGE, Neukirchen (DE)

(73) Assignee: Clariant International Ltd., Muttenz (CH)

(21) Appl. No.: 18/032,474

(22) PCT Filed: Aug. 30, 2021
(86) PCT No.: PCT/EP2021/073841

§ 371 Date: Apr. 18, 2023

(30) Foreign Application Priority Data
Oct. 20, 2020 (EP) 20202793.4

(51) Int. Cl. C08G 65/34; B01J 19/00; B01J 23/04; B01J 23/10

(52) U.S. Cl. CPC C08G 65/34; B01J 19/0013; B01J 23/04; B01J 23/10

(57) ABSTRACT

The invention relates to a process for preparing polyether alcohols by reacting one or more alkylene oxides having one or more H-functional starting substances in a continuous reactor that comprises flow channels, at a temperature of 180° C. to 250° C. and a pressure of 60 to 150 bar in the presence of a basic, metal-containing catalyst, wherein the concentration of the catalyst, based on the total amount of reaction mixture of alkylene oxide, H-functional starting substance and catalyst, is no more than 50 ppm by weight, and the residence time of the reaction mixture in the reactor is 15 to 120 minutes.

The invention relates to a process for producing polyether alcohols having a low metal ion content which is carried out in microstructured reactors.

Polyether alcohols may be polyether polyols or else polyether monools. These are used in various fields of application, in particular as surface-active substances, washing and cleaning compositions, in mining, in construction chemicals, as oilfield chemicals, in textile or leather processing, as coatings, as formulation auxiliaries for plant protection products, as cosmetics and personal care products, as formulation auxiliaries for human and animal nutrition, for pigments, for pharmaceuticals or as fuel additives. Polyether alcohols are also used in the manufacture of polyurethanes.

In addition to production in conventional batch reactors, production of polyether alcohols in continuous fashion in reactors comprising a plurality of mutually parallel microstructured layers is also known. Microstructured reactors contain capillaries in which a chemical reaction is carried out.

EP-A 1 586 372 describes a microstructured reactor and the use thereof in a process for producing polyether alcohols by ring-opening addition reaction of short-chain alkylene oxides in the presence of a solid catalyst, wherein the chemical process is carried out in spaces formed by two or more substantially plane-parallel plates or layers and wherein the reactant mixing is carried out monophasically in the liquid phase in each reaction channel individually, a heat exchanger apparatus is provided and the reactor is configured for pressures up to 800 bar and temperatures in the range from 30° C. to 400° C. This makes it possible to optimally utilize the potential of very high reaction rates at high alkylene oxide pressures and produce polyether alcohols of uniform quality and having a low content of byproducts.

DE-A-10 2010 039 090 teaches a process for producing polyether alcohols by reaction of the following reactants:
a) one or more alkylene oxides and optionally carbon dioxide and
b) one or more H-functional starter substances, in the presence of a catalyst, to form a liquid reaction mixture in a reaction unit (1),
characterized in that the reaction unit (1) has internals (2) which form a multiplicity of microstructured flow channels which bring about multiple splitting of the liquid reaction mixture into substream paths and renewed recombination thereof in altered arrangement, wherein the multiple splitting and renewed recombination is repeated multiple times and wherein the microstructured flow channels have a characteristic dimension which is defined as the maximum possible distance of a particular particle of the liquid reaction mixture to the wall of a flow channel closest to the particle in the range from 20 to 10 000 μm and in that the flow profile of the liquid reaction mixture through the microstructured flow channels approaches ideal plug flow.

WO-2007/135154 teaches a process for producing polyether polyols by reaction of the following reactants:
a) one or more alkylene oxides and optionally carbon dioxide and
b) one or more H-functional starter substances,
in the presence of a catalyst, in a reaction unit with a plurality of mutually parallel layers A and B which are microstructured such that every layer comprises a multiplicity of mutually parallel channels which form a continuous flow path from one side of the plate to the opposite side thereof, characterized in that for the channels of the layers A a distributing means for supplying the reactants and the catalyst is provided at one end of said layers and a collecting means for the reaction mixture is provided at the other end of said layers.

However, microstructured reactors are very difficult constructions. Even during manufacture, the tolerances are such that especially for reaction systems noticeably increasing in viscosity over the duration of the reaction, as is the case in the production of polyether alcohols, the pressure drop over the individual capillaries relative to one another results in maldistribution of the mass flows. This problem is described in detail in C. Amador et al., Chem. Eng. J. 101 (2004) 1-3, pages 379-390. There have been efforts at avoiding maldistribution in tubular apparatuses connected in parallel since as long ago as the 1980s. Approaches which promote uniform distribution of the mass flows even in viscosity-increasing systems have been developed. Just as the pressure losses of the individual capillaries must be taken into account when supplying the microstructured reactor, this effect must also be taken into account during subsequent metered addition.

Furthermore, the process for producing polyether alcohols entails very high pressures which necessitate a reactor configuration for up to several hundred bar.

Hessel et. al. report that the use of novel process windows makes it possible to switch the process management from effective kinetics limited by heat and mass transfer limitation, as are customary today, to intrinsic kinetics of the reaction. To this end, Hessel et. al. define the manner of running reactions hitherto generally referred to as “drastic reaction conditions” with the term “novel process windows” [HESSEL, V.:

Novel Process Windows—Gates to Maximizing Process Intensification via Flow Chemistry in: Chemical Engineering & Technology 32 (2009), no. 11, pages 1655-1681; ILLG, T.; LOB, P.; HESSEL, V.: Flow chemistry using milli- and microstructured reactors—From conventional to novel process windows in: Bioorganic & Medicinal Chemistry 18 (2010), no. 11, pages 3707-3719—HESSEL, V.; CORTESE, B.; CROON, M. H. J. M. de: Novel process windows—Concept, proposition and evaluation methodology, and intensified superheated processing. in: Chemical Engineering Science 66 (2011), no. 7, pages 1426-1448]. The novel process windows provide new possibilities for performing reaction process:
chemical reactions that are not controllable with conventional reaction technology and thus not utilizable
reaction routes at greatly elevated temperature
reaction routes at greatly elevated temperature
reaction routes at greatly elevated concentration or without solvents
process integration for overall optimization of chemical processes
reaction routes in the explosive range or reactions that undergo thermal runaway

The objective of the novel process window is a shift of the reaction duration of many reactions from the range of 100 seconds to 1000 seconds to the single-figure seconds range. Hessel et. al. cite several EU initiatives in their publications that aim to make chemical production more sustainable, more cost-effective and more flexible using the novel process windows.

Common to all known processes and applications of novel process windows is the objective of accelerating the reaction by utilizing intrinsic kinetics and eliminating mass and heat transfer limitations. Also common to all known processes and applications of novel process windows is a downstream workup of the products produced.

Especially when utilizing polyether alcohols for the production of polyurethanes a low content of metal ions in the end product is an essential quality criterion having a decisive influence on the usability of the end product. The production of polyether alcohols typically employs alkali metal hydroxides or alkali metal alkoxides as catalysts in relatively high concentrations of 100 to 50 000 ppm based on the total weight of the input materials. To be able to ensure a low metal ion content in the end product the polyether alcohol production is preferably followed by a workup to remove these basic catalysts. The polyether alcohols are neutralized and the metal salt or hydroxides removed from the polyether alcohols. The neutralization is generally carried out with aqueous organic or inorganic acids such as for example CO₂, sulfuric acid, phosphoric acid, hydrochloric acid, lactic acid, acetic acid or similar compounds. The salts formed are then either precipitated and removed by filtration or centrifugation or separated in the aqueous phase via ion exchangers or coalescers. Separation is generally followed by drying of the polyether alcohols where at temperatures between 80° C. and 160° C. at a reduced pressure of 5-500 mbar and if required with addition of an entrainment gas such as steam or nitrogen the residual water is removed and the polyether alcohol is freed of disruptive impurities such as odorous substances. This final workup step such as for the removal of odorous substances is generally also employed in the case of catalysts that need not be removed from the reaction mixture. Such catalysts include for example DMC catalysts or amines, for example imidazoles, dimethylalkanolamines or other metal-free catalysts.

It was accordingly an object of the present invention to provide a process for producing polyether alcohols under basic metal catalysis in a continuously operated reactor which is improved over known processes in that the cost- and energy-intensive workup of the polyether alcohols to remove the metal-containing catalyst is avoided. The resulting products shall be directly employable for applications in the polyurethane sector. To this end an upper limit of the metal content of 20 ppm is to be observed. The low reaction rate, which is a consequence of the low catalyst concentration required therefor, must be compensated.

The present invention therefore relates to a process for producing polyether alcohols by reaction of one or more alkylene oxides and one or more H-functional starter substances in a continuously operated reactor comprising flow channels at a temperature of 180° C. to 250° C. and a pressure of 60 to 150 bar in the presence of a metal-containing catalyst, wherein the concentration of the catalyst reported as the metal content, based on the total amount of reaction mixture composed of alkylene oxide, H-functional starter substance and catalyst, is not more than 20 ppmw and the residence time of the reaction mixture in the reactor is from 15 to 120 minutes.

Contemplated alkylene oxides include all oxiranes. It is preferable to employ ethylene oxide, propylene oxide, butylene oxide, pentene oxide, glycidyl ether, hexene oxide and/or styrene oxide, particularly preferably ethylene oxide, propylene oxide and mixtures thereof.

The H-functional starter substance is a compound having at least one alkoxylation-active hydrogen atom. Suitable H-functional starter substances preferably include alcohols having a functionality of 1 to 8, preferably of 2 to 8, particularly preferably of 2 to 6, more preferably of 2 to 4. Functionality is to be understood as meaning the number of OH groups per mol of starter substance.

Preferred H-functional starter substances having a functionality greater than 1 include for example ethylene glycol, propylene glycol, diethylene glycol, dipropylene glycol, glycerol, trimethylolpropane, pentaerythritol, sucrose, saccharose, glucose, fructose, mannose, sorbitol, hydroxyalkylated (meth)acrylic acid derivatives and alkoxylated derivatives of the abovementioned H-functional starter substances up to a molecular weight of about 1500 D.

Suitable H-functional starter substances include one or more alcohols having a functionality of 1 and having the general formula R—OH, wherein R is an alkyl-, alkenyl-, aryl-, aralkyl or alkylaryl radical having 1 to 60, preferably 1 to 24, carbon atoms. Preferred alkylaryl radicals are those comprising to Cis-alkyl groups. Particular preferred alcohols include for example methanol, butanol, hexanol, heptanol, octanol, decanol, undecanol, dodecanol or tridecanol, tetradecanol, pentadecanol, hexadecanol, heptadecanol, octadecanol, butenol, hexenol, heptenol, octenol, nonenol, decenol, undecenol, vinyl alcohol, allyl alcohol, geraniol, linalool, citronellol, phenol or nonylphenol.

It is also possible to employ primary and/or secondary amines and thiol as starters. It is also possible to use compounds containing both OH groups and allyl or vinyl groups, for example vinyl or (meth)allyl alcohol and their etherification products with polyhydric alcohols, which may be used as starting products in a downstream free-radical polymerization.

Employable catalysts preferably include alkali metal or alkaline earth metal hydroxides, preferably sodium hydroxide, potassium hydroxide and caesium hydroxide and also other basic catalysts, such as alkali metal alkoxides. In addition to soluble basic catalysts it is also possible to employ insoluble basic catalysts, such as magnesium hydroxide or hydrotalcite.

The concentration of the catalysts reported as the metal content for alkali metal hydroxides or alkali metal alkoxides for the process according to the invention is preferably in the range from 1 to 50 ppm, in particular 5 to 30 ppm, particularly preferably 5 to 20 ppm, based on the total weight of the reaction mixture. The term “reported as the metal content” is to be understood as meaning that calculation of the catalyst concentration takes into account only the weight of the metal present in the catalyst but not the weight of hydroxides or alkoxides for example.

The process is operated such that the pressure in the flow channels is in the range from 60 to 150 bar, in particular 80 to 120 bar.

The process is operated such that the temperature in the flow channels is in the range from 180° C. to 250° C., in particular 190° C. to 230° C.

The process is operated such that the residence time of the reaction mixture in the flow channels is between 15 and 120 minutes, preferably 20 to 100 minutes.

It is possible to employ only a single alkylene oxide or else two or more alkylene oxides as the reactant. Both a blockwise addition reaction, where the alkylene oxides are subject to successive addition reaction, or a random addition reaction, where the alkylene oxides are metered in together, are suitable. Hybrid forms, where both blocks and random sections are incorporated into the polyether chain, are also possible. The reactants are preferably employed in a ratio of 1 to 300 equivalents of one or more alkylene oxides per equivalent of one or more H-functional starter substances.

It is preferable when a portion of the reactants or all of the reactants and optionally the catalyst are initially premixed outside the flow channels of the reactor, wherein it is ensured that the temperature during premixing is lower than the temperature of the subsequent reaction. The temperature and pressure during mixing must be selected such that the material being mixed is liquid.

A microstructured mixer is preferably used as the mixer arranged outside the reactor, wherein a portion of the reactants or all reactants and optionally the catalyst are premixed. Microstructured mixers comprise capillaries in which the mixing is carried out. Suitable apparatuses include for example laminar diffusion mixers, multilamination mixers, micromixers having structured walls or split-recombine mixers.

Laminar diffusion mixers effect mixing of substreams of the fluid that has been split up by a microstructure into a multiplicity of microscopic flow lamellae having a thickness in the range from 10 to 2000 μm or else 20 to 1000 μm or else 40 to 500 μm exclusively by molecular diffusion perpendicular to the main flow direction. An approximate configuration of the mixer may be effected via the Fourier number Fo=τ/τD. If the residence time τ is at least of the order of magnitude of the diffusion time τD for the transverse mixing, i.e. if the Fourier number is at least 1, virtually complete molecular mixing is achieved at the outlet of the mixture.

Laminar diffusion mixers may be in the form of simple T or Y mixers or in the form of so-called multilamination mixers. In the case of the T or Y mixer the two substreams to be mixed are supplied to a single channel through a T- or Y-shaped arrangement. The transversal diffusion path SDiff depends decisively on the channel width OK. Typical channel widths between 100 μm and 1 mm result in very short mixing times of less than 100 ms for gases while those of liquids are in the minutes range. When mixing liquids, such as in the case of the present process, it is advantageous to provide additional assistance to the mixing operation, for example through flow-induced transverse mixing.

In the case of multilamination mixers the substreams to be mixed are geometrically separated into a multiplicity of stream filaments in a distributor and then alternately supplied to lamellae of the mixing section at the outlet of the distributor. For liquids the classical multilamination mixers achieve mixing times in the seconds range. Since this is inadequate for some applications (for example in the case of rapid reactions) the basic principle was further developed so as to achieve additional geometric or hydrodynamic focussing of the flow lamellae. In the case of geometric focusing this is achieved by a narrowing in the mixing section and in the case of hydrodynamic focusing this is achieved by two sidestreams which perpendicularly impinge the main stream and thus further compress the flow lamellae. The described focusing makes it possible to achieve lateral dimensions of the flow lamellae of just a few micrometers so that even liquids may be mixed within a few 10 s of ms.

In the case of micromixers having structured walls, secondary structures, for example serrations or flutes, are arranged on the channel walls at a certain angle to the main flow direction, preferably of 45° or 90°.

Split-recombine mixers are characterized by stages of repeated separation and combination of streams. In each of these stages, the number of lamellas is successively doubled, thereby halving the lamella thickness and diffusion path. The residence time in the premixing stage of the process is preferably in the range from 1 to 300 seconds.

The premixed reactants are supplied to a reactor which preferably contains a plurality of parallel, alternatingly superposed and microstructured layers of reaction channels and temperature-control channels such that every layer comprises a multiplicity of mutually parallel channels which form a continuous flow path from one side of the layer to the opposite side thereof.

A layer is presently to be understood as meaning a largely two-dimensional, flat modular unit, i.e. a modular unit whose thickness is negligibly small relative to its surface area. It is preferably a substantially flat plate.

The layers, in particular plates, in the reactor and mixer are microstructured such that they comprise channels that are traversed by the reaction mixture (so-called reaction channels) or heat transfer medium (so-called temperature control channels). As is customary, the term “microstructured” is to be understood as meaning that the average hydraulic diameter of the channels is <1 mm.

In one embodiment the reactor may comprise layers A and layers B. In this case layers B which have a heat-transfer medium supplied to them on one side and withdrawn from them on the other side are arranged alternatingly with the layers A traversed by the reaction mixture. It is thus possible for the alternating arrangement of the layers A and B to be configured such that every layer A is followed by a respective layer B or that every two successive layers A are followed by a respective layer B or that every two successive layers B are followed by a respective layer A.

The layers A contain the flow channels of the reactor. The embodiments described here for the layer A generally also apply to the configuration of the reactor when said reactor does not comprise layers A and B but only layers A.

After premixing a portion or all of the reactants the resulting mixture and optionally additional reactants not mixed therewith are supplied to the channels in the layers A on one side of said layers and the reaction mixture is withdrawn from the other side of said layers.

According to the invention the channels of the layers A have a distributing means for supplying the reactants and the catalyst provided at one end of said layers and a collecting means for the reaction mixture provided at the other end of said layers.

In one embodiment the distributing means and the collecting means are each in the form of a chamber arranged outside or inside the stack of the layers A and B. The walls of the chamber may be straight or follow a semicircular arc for example. What is essential is that the geometric shape of the chamber is suitable to arrange flow and pressure drop such that the flow through all subsequent channels is uniform.

In one embodiment the distributing means and the collecting means are each arranged inside the stack of the layers A and B such that the mutually parallel channels of each layer A in the region of each of the two ends of said layer each comprise a transverse channel connecting the mutually parallel channels and all transverse channels inside the stack of layers A and B are connected via a collecting channel arranged substantially perpendicular to the plane of the layers A and B. The same principle of uniform distribution specified in the preceding paragraph also applies to these channels.

In one embodiment the layers B, whose channels are traversed by the-heat transfer medium, also each have a distributing means and a collecting means corresponding to the distributing means and the collecting means for the layers A.

It is advantageous to perform the process in such a way that the channels of every layer A follow a temperature profile in which two or more heating or cooling zones, each comprising at least one distributing means and collecting means per heating or cooling zone of the layers B, are provided per layer for corresponding temperature-control of the reaction mixture in the channels of the layers A.

The process according to the invention especially has the feature that it avoids/minimizes workup of the polyether alcohols produced in the sense of removing the catalyst, neutralization and removal of odorous substances. This makes it possible for example to eschew the removal of the alkali metal or alkaline earth metal ions, the strict requirements with regard to metal ion content for polyether alcohols used, for example, in the automotive and polyurethane sectors already being met by the crude material.

### EXEMPLARY EMBODIMENTS

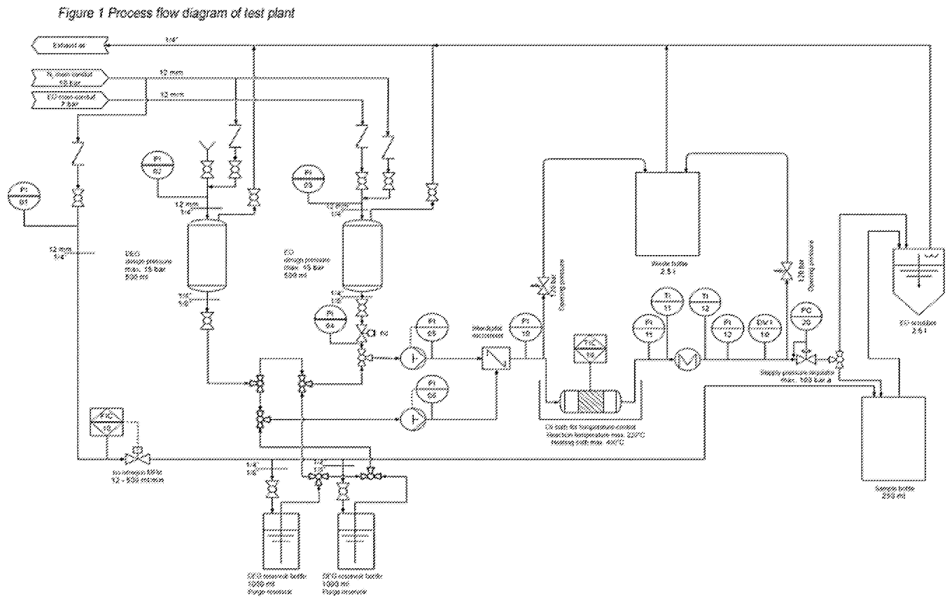

A continuously operated flow apparatus was constructed for the exemplary embodiments (FIG. 1). The test plant is configured for 100 bar (absolute pressure) to ensure that ethylene oxide remains liquid in the reactor even at temperatures up to 220° C. A simple flow tube reactor was used to study the reactions. The flow tube reactor consisted of a stainless steel tube having an external diameter of 3 mm and an internal diameter of 1.6 mm (Swagelok, 50 m in length, internal volume of 100 ml realizable).

The test plant has 2 pressure vessels (Büchi, design pressure 15 bar abs., see FIG. 1) of 500 ml in volume for the provision of EO and DEG. Both vessels may be pressurized with nitrogen from a nitrogen line (10 bar) to provide sufficient supply pressure for two HPLC pumps and to avoid outgassing of the EO due to the strokes of the pistons. In case of bubble formation in the pistons of the HPLC pump the pump may no longer convey liquid. To purge the EO pump the DEG pressure vessel may also be switched to this pump. Two further atmospheric pressure vessels, each of one liter in volume, are also available for purging the pumps.

Downstream of the pumps both material streams are mixed in an interdigital mixer (Ehrfeld Mikrotechnik) and then passed into the reactor. The product flow is cooled via a heat exchanger (Ehrfeld Mikrotechnik) downstream of the reactor. A pressure regulator (KPB series, Swagelok) makes it possible to adjust the plant pressure to 137 bar. Three pressure sensors (Keller, in modules from Ehrfeld Mikrotechnik) make it possible to capture and plot the pressure upstream of the reactor, upstream of the heat exchanger and upstream of the pressure regulator of the test plant.

For protection of the plant, respective pressure relief valves (Swagelok) adjusted to 120 bar abs are installed upstream of the reactor and upstream of the pressure controller. This ensures that in the event of a blockage in the reactor or in the region of the pressure regulator, even in the event of failure of the automatic shutdown of the HPLC pumps (max. pressure 120 bar) fails, a depressurization of the plant is possible.

The reactor is kept at the correct temperature via a heating bath under closed-loop control in which the reactor is immersed. To capture and plot the temperature of the product stream, respective Pt-100 thermocouple modules (Ehrfeld Mikrotechnik) are installed upstream and downstream of the heat exchanger.

### EXAMPLE 1

Substrate: Diethylene glycol (DEG)
Catalyst: sodium hydroxide, 50% aqueous solution
Catalyst concentration: 0.0155 (% by wt. based on DEG)
Metered addition rate of DEG+catalyst: 0.64 ml/min; metered addition rate of EO: 2.03 ml/min
Reactor temperature: 210° C.
Pressure: 95 bar abs
Residence time: 45 min

### EXAMPLE 2

Substrate: Diethylene glycol (DEG)
Catalyst: sodium hydroxide, 50% aqueous solution
Catalyst concentration: 0.0155 (% by wt. based on DEG)
Metered addition rate of DEG+catalyst: 0.82 ml/min; metered addition rate of EO: 2.6 ml/min
Reactor temperature: 220° C.
Pressure: 95 bar abs
Residence time: 35 min

### EXAMPLE 3

Substrate: Diethylene glycol (DEG)
Catalyst: sodium hydroxide, 50% aqueous solution
Catalyst concentration: 0.0155 (% by wt. based on DEG)
Metered addition rate of DEG+catalyst: 1.15 ml/min; metered addition rate of EO: 3.65 ml/min
Reactor temperature: 230° C.
Pressure: 95 bar abs
Residence time: 25 min

### EXAMPLE 4

Substrate: Diethylene glycol (DEG)
Catalyst: sodium hydroxide, 50% aqueous solution
Catalyst concentration: 0.0155 (% by wt. based on DEG)
Metered addition rate of DEG+catalyst: 1.15 ml/min; metered addition rate of EO: 3.64 ml/min
Reactor temperature: 220° C.
Pressure: 95 bar abs
Residence time: 25 min

### EXAMPLE 5

Substrate: Diethylene glycol (DEG)
Catalyst: sodium hydroxide, 50% aqueous solution
Catalyst concentration: 0.0155 (% by wt. based on DEG)
Metered addition rate of DEG+catalyst: 0.64 ml/min; metered addition rate of EO: 2.03 ml/min
Reactor temperature: 220° C.
Pressure: 95 bar abs
Residence time: 45 min

### EXAMPLE 6

Substrate: Diethylene glycol (DEG)
Catalyst: sodium hydroxide, 50% aqueous solution
Catalyst concentration: 0.0155 (% by wt. based on DEG)
Metered addition rate of DEG+catalyst: 0.48 ml/min; metered addition rate of EO: 1.52 ml/min
Reactor temperature: 220° C.
Pressure: 95 bar abs
Residence time: 45 min

### EXAMPLE 7

Substrate: Diethylene glycol (DEG)
Catalyst: sodium hydroxide, 50% aqueous solution
Catalyst concentration: 0.155 (% by wt. based on DEG)
Metered addition rate of DEG+catalyst: 1.15 ml/min; metered addition rate of EO: 3.64 ml/min
Reactor temperature: 180° C.
Pressure: 95 bar abs
Residence time: 25 min

| | | | NaOH | | | |
|---|---|---|---|---|---|---|
| | | | (50%) | | | |
| | | | [% by | | | |
| | | | wt. | | Sodium | Ethylene |
| | Temper- | Residence | based | Metal | in | oxide |
| Ex- | ature | time | on | content | product | in product |
| ample | τ/° C. | τ/min | DEG] | [ppm] | [ppm] | [ppm] |
| 1 | 210 | 45 | 0.0155 | 44.6 | 13 | 1000 |
| 2 | 220 | 35 | 0.0155 | 44.6 | 21 | 23 |
| 3 | 230 | 25 | 0.0155 | 44.6 | 14 | 2000 |
| 4 | 220 | 25 | 0.0155 | 44.6 | 21 | 8000 |
| 5 | 220 | 45 | 0.0155 | 44.6 | 12 | 1 |
| 6 | 220 | 60 | 0.0155 | 44.6 | 12 | <0.5 |
| 7 (C) | 180 | 25 | 0.155 | 446 | 120 | 200 |

The EO content in the product indicates completeness of reaction. Preferably very little, if any, EO should remain after the reaction since it is toxic/explosive and may have to be removed at higher concentrations. Furthermore, complete conversion is desired to ensure the correct stoichiometry and to ensure that the low metal ion contents based on the mass of the end product are achieved.

Shorter residence times <600 s lead to incomplete reaction and would result in unreacted ethylene oxide being discharged from the reactor. This result was obtained experimentally. Ethylene oxide is a toxic/explosive gas. Such an experiment should not be carried out for safety reasons. Due to the incomplete reaction and the gaseous reactant ethylene oxide, no meaningful analytical evaluation of the experiment would be possible either.

1. A process for producing a polyether alcohol by the steps of reacting one or more alkylene oxides with one or more H-functional starter substances in a continuously operated reactor, wherein the continuously operated reactor comprises flow channels at a temperature of 180° C. to 250° C. and a pressure of 60 to 150 bar in the presence of a basic, metal-containing catalyst, wherein the concentration of the catalyst reported as the metal content, based on the total amount of a reaction mixture composed of alkylene oxide, H-functional starter substance and catalyst, is not more than 50 ppm by weight, and the residence time of the reaction mixture in the reactor is from 15 to 120 minutes.

2. The process as claimed in claim 1, wherein hydroxides or alkoxides of alkali metals and/or alkaline earth earth metals, are used as the catalyst.

3. The process as claimed in claim 1, wherein the concentration of the catalyst reported as the metal content is 1 to 50 ppm.

4. The process as claimed in claim 1, wherein hydroxides or alkoxides of alkali metals selected from the group consisting of sodium or potassium are used as the catalyst, and wherein the sum of the concentrations of Na ions and K ions in the polyether alcohol is at most 30 ppm.

5. The process as claimed in claim 1, wherein the reactor contains a plurality of parallel, alternatingly superposed and microstructured layers of reaction channels and temperature-control channels.

6. The process as claimed in claim 1, wherein the pressure and temperature are chosen such that the reaction mixture remains liquid at all times.

7. The process as claimed in claim 1, wherein the residence time of the reaction mixture in the reactor is between 20 and 100 minutes.

8. The process as claimed in claim 1, wherein the flow axis of the reactor follows a temperature profile and the reactor comprises two or more heating or cooling zones having at least one distributing means and at least one collecting means per heating or cooling zone.

9. The process as claimed in claim 1, wherein the alkylene oxide is selected from the group consisting of ethylene oxide, propylene oxide, butylene oxide, pentene oxide, glycidyl ether, hexene oxide and styrene oxide, preferably ethylene oxide, propylene oxide and mixtures thereof.

10. The process as claimed in claim 1, wherein the H-functional starter substance comprises an alcohol having a functionality of 1 to 8.

11. The process as claimed in claim 1, wherein the H-functional starter substance is an alkoxylate containing units of ethylene oxide and units of propylene oxide.

12. The process as claimed in claim 11, in which the units of ethylene oxide and units of propylene oxide are arranged blockwise.

13. The process as claimed in claim 1, wherein the H-functional starter substance comprises an alcohol having a functionality of 1 and conforming to the general formula R—OH, wherein R is an alkyl-, alkenyl-, aryl-, aralkyl or alkylaryl radical having 1 to 60 carbon atoms.

14. The process as claimed in claim 13, in which the H-functional starter substance is selected from methanol, butanol, hexanol, heptanol, octanol, decanol, undecanol, dodecanol, tridecanol, tetradecanol, pentadecanol, hexadecanol, heptadecanol, octadecanol, butenol, hexenol, heptenol, octenol, nonenol, decenol, undecenol, vinyl alcohol, allyl alcohol, geraniol, linalool, citronellol, phenol, nonylphenol, and mixtures thereof.

15. The process as claimed in claim 1, wherein the H-functional starter substance comprises one or more alcohols having a functionality of 2 to 8.

16. The process as claimed in claim 1, wherein the H-functional starter substance is one or more alcohols selected from the group consisting of ethylene glycol, propylene glycol, diethylene glycol, dipropylene glycol, glycerol, trimethylolpropane, pentaerythritol, sucrose, saccharose, glucose, fructose, mannose, sorbitol, hydroxyalkylated (meth)acrylic acid derivatives and alkoxylated derivatives of the abovementioned H-functional starter substances up to a molecular weight of 1500 D.

17. The process as claimed in claim 1, wherein a mixer is arranged upstream of the reactor.

18. The process as claimed in claim 17, in which the mixer is a microstructured mixer arranged outside the reactor.

19. The process as claimed in claim 1, wherein basic catalysts are used as the catalyst.

20. The process as claimed in claim 1, wherein the catalyst comprises an alkali or alkaline earth metal hydroxide and/or alkali metal alkoxide.

21. The process as claimed in claim 1, wherein the catalyst is selected from sodium hydroxide, potassium hydroxide and cesium hydroxide.

22. The process as claimed in claim 1, wherein the catalyst is present in a concentration of 5 to 30 ppm, based on the total weight of the reaction mixture.
